(19) United States
(12) Patent Application Publication
(10) Pub. No.: US 2026/0366620 A1
(43) Pub. Date: Nov. 19, 2026

(54) Flange gasket with material identification tag

(71) Applicant: Kilynn a Carter, Wickenburg, AZ (US)

(72) Inventor: Kilynn a Carter, Wickenburg, AZ (US)

(21) Appl. No.: 19/207,610

(22) Filed: May 14, 2025

(51) Int. Cl. F16J 15/06

(52) U.S. Cl. CPC F16J 15/064

(57) ABSTRACT

A flange gasket includes a gasket body configured to be positioned between opposing flange sealing surfaces to form a fluid-tight seal and an identification element integrally formed with the gasket body. The identification element is formed of the same material as the gasket body and provides information identifying at least a material composition of the flange gasket. The identification element extends from a peripheral region of the gasket body and is positioned outside a compressed sealing region of the gasket body when installed, such that the identification element does not interfere with sealing engagement between the opposing flange sealing surfaces. The identification element remains with the flange gasket during handling, installation, and service and is configured to withstand conditions encountered during installation and use.

### CROSS-REFERENCE TO RELATED APPLICATIONS

Not Applicable

### BACKGROUND OF THE INVENTION

Flange Gaskets are visually similar in appearance despite being fabricated from different materials or having different pressure ratings or service limitations. Once installed, or after removal from original packaging, it may be difficult or impossible to readily identify the flange gasket material, rating, or intended service without specialized knowledge or destructive testing. Field operators often rely on subjective methods—such as smelling or “sniffing” a gasket—to attempt to identify the material type. This informal and inconsistent approach can lead to misidentification, variability between operators, and potential safety and quality risks. Conventional approaches to gasket identification typically rely on external packaging, color markings, printed labels, separate documentation or sniffing the gasket. This lack of clear identification can lead to installation errors, improper use, and uncertainty during inspection, maintenance, or system modification and major safety hazards. These methods are often lost, damaged, obscured, or rendered unreadable during handling, storage, or installation. In some cases, identification markings may be removed or degraded by environmental exposure, compression, or contact with process fluids. As a result, installers, maintenance personnel, and inspectors may be unable to reliably confirm flange gasket material or suitability for a given application. Inadequate or uncertain flange gasket identification can contribute to improper material selection, reduced sealing performance, premature failure, or non-compliance with applicable specifications or safety requirements. There is therefore a need for an improved flange gasket configuration that provides reliable, durable, and readily accessible material identification integrally formed directly with the gasket itself, without adversely affecting sealing performance or installation.

### (1) FIELD OF THE INVENTION

The present invention relates generally to industrial and commercial sealing components, and more particularly to flange gaskets incorporating an integrated material identification feature for use in piping, fluid handling, and mechanical joint applications.

### BRIEF SUMMARY OF THE INVENTION

The present invention provides a Flange gasket having an integrated material identification feature that enables reliable identification of the flange gasket material during installation, post-installation inspection, and maintenance. The identification feature is integrally formed directly with the flange gasket such that it remains with the gasket throughout handling and use, without interfering with the gasket's primary sealing function. The invention further contemplates methods of manufacturing and using a flange gasket with a material identification feature manufactured from the gasket material during manufacturing guarantees the identification shall remain intact for the life of the flange gasket. The present invention provides a flange gasket having an integrated material identification feature that enables reliable identification of the flange gasket material before, during and after installation, post-installation inspection, and maintenance. By providing identification directly with the flange gasket, the invention improves traceability, reduces installation errors, facilitates inspection, maintenance and most importantly reduces safety hazards in manufacturing chemicals or with chemicals and doesn't require separate packaging, documentation, or destructive testing.

### BRIEF DESCRIPTION OF THE SEVERAL VIEWS OF THE DRAWING(S)

FIG. 1 shows: is a view of flange gaskets including the material identification tag, in accordance with an embodiment of the present invention.

FIG. 2 shows: is an enlarged detailed view of the material identification element integrally formed with the flange gasket body.

FIG. 3 shows: is an enlarged detailed view of the material identification element integrally formed with the flange gasket body.

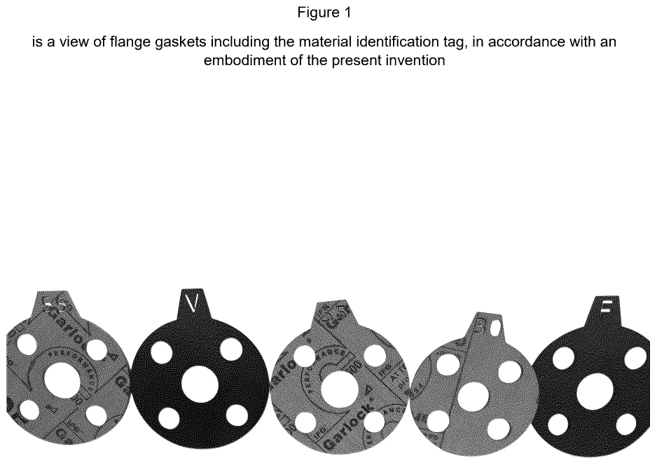

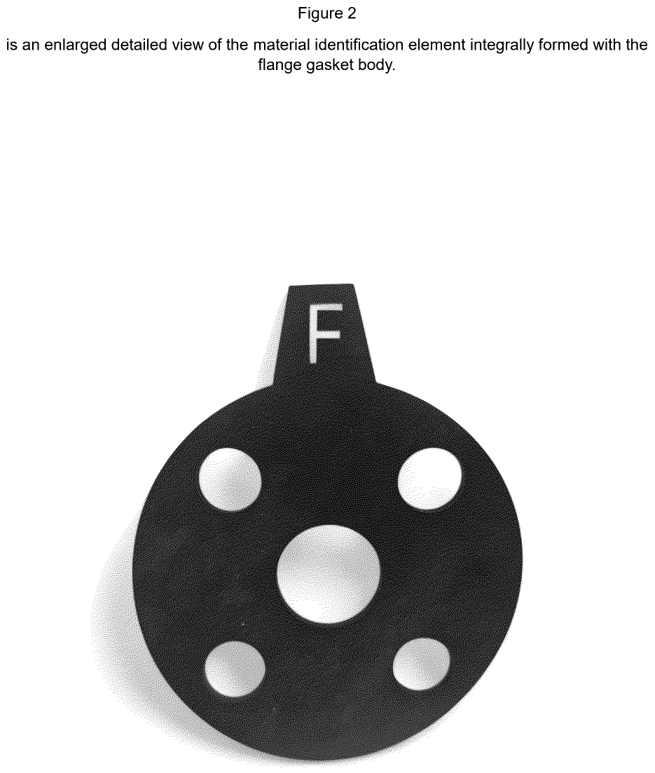

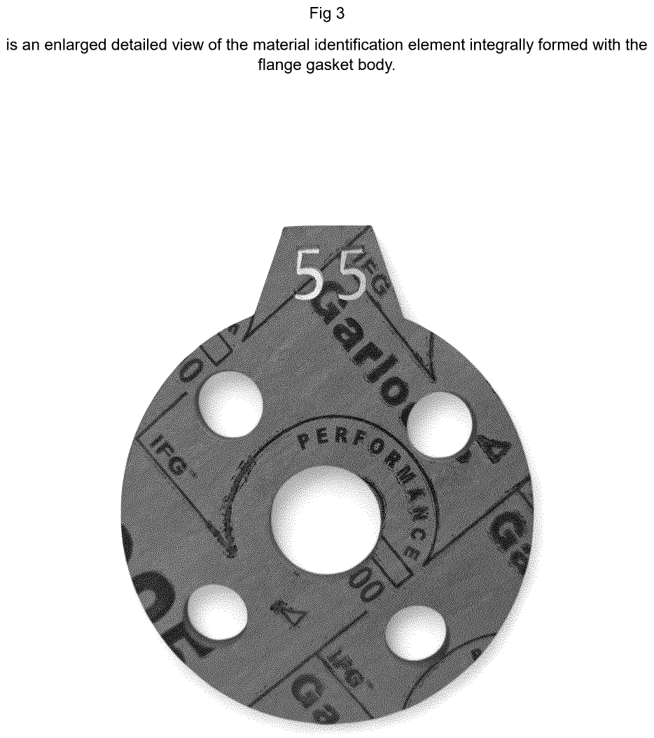

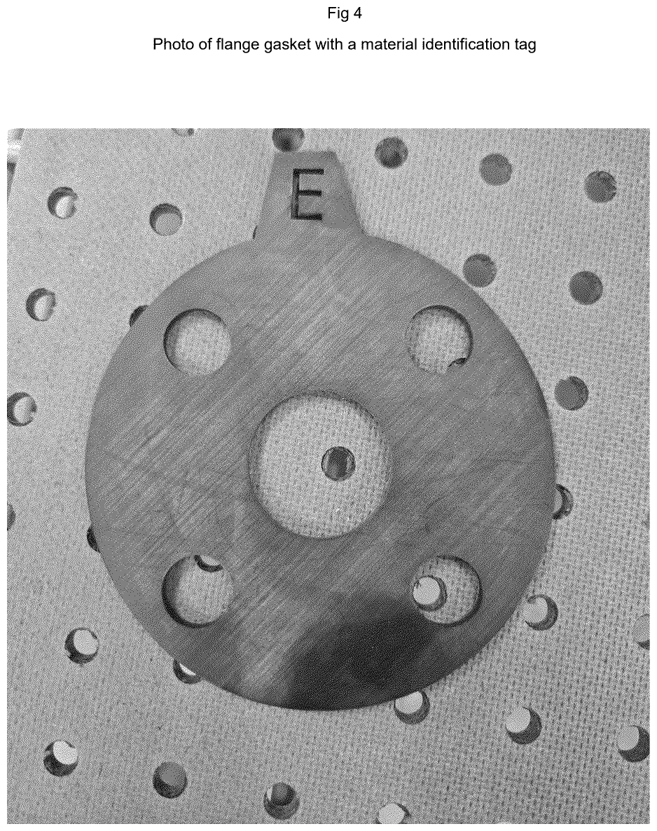

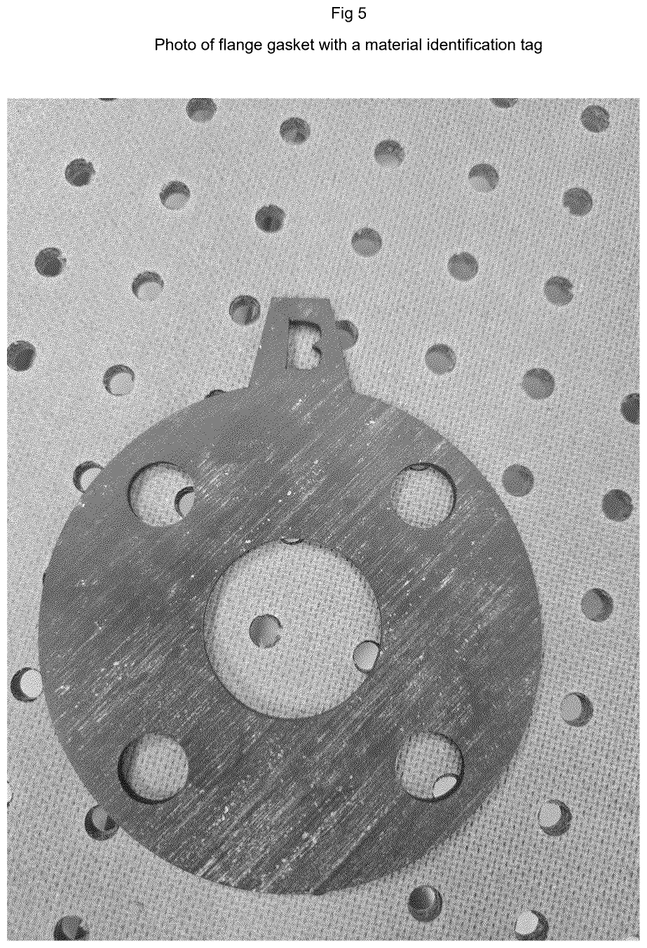

### DETAILED DESCRIPTION OF THE INVENTION

Gasket body—The invention includes a flange gasket body sized and shaped for installation between mating sealing surfaces of a piping, valves, processing equipment and mechanical joints. The flange gasket body may be configured as a ring-type gasket, a full-face gasket, or another gasket configuration suitable for use with standard or non-standard sealing surface geometries. The flange gasket body may be formed from any suitable sealing material, including but not limited to elastomeric materials, polymeric materials, graphite, compressed fiber materials, composite materials, metallic materials, or combinations thereof. Material selection may be based on operating conditions such as pressure, temperature, chemical exposure, and mechanical loading. The flange gasket body defines a primary sealing region that is compressed between opposing sealing surfaces to form a fluid-tight seal. Regions of the flange gasket body outside the primary sealing region may be configured to accommodate features that do not directly participate in sealing.

Identification Element—The flange gasket further includes an identification element integrally formed with the flange gasket body. The identification element is configured to provide information identifying at least one characteristic of the flange gasket, such as material type. The identification element shall be positioned outside the primary sealing region so as not to interfere with sealing performance. The identification element is located radially outward of a bolt circle or at an outer peripheral portion of the flange gasket.

1. A flange gasket, comprising: a gasket body configured to be positioned between opposing flange sealing surfaces to form a fluid-tight seal; and an identification tag integrally formed with the gasket body and extending outwardly from a peripheral edge of the gasket body, wherein the identification tag is formed of the same material as the gasket body and is positioned outside a compressed sealing region of the gasket body when the flange gasket is installed, such that the identification tag does not interfere with sealing engagement between the opposing flange sealing surfaces.

2. The flange gasket of claim 1, wherein the gasket body and the identification tag are co-cut from a single sheet of gasket material.

3. The flange gasket of claim 1, wherein the identification tag extends radially outward beyond an outer diameter of the opposing flange sealing surfaces when installed.

4. The flange gasket of claim 1, wherein the identification tag includes visually readable indicia identifying a material composition of the gasket body.

5. The flange gasket of claim 1, wherein the identification tag remains visible and readable after installation of the flange gasket between the opposing flange sealing surfaces.

6. The flange gasket of claim 1, wherein the gasket body and the identification tag are formed from an elastomeric material, a polymeric material, graphite, compressed fiber, a composite material, or a metallic gasket material.

7. The flange gasket of claim 1, wherein the identification tag is configured to withstand at least one of elevated temperature exposure, chemical exposure, or pressure cycling without detaching from the gasket body.
